(19) United States
(12) Patent Application Publication
(10) Pub. No.: US 2016/0206131 A1
(43) Pub. Date: Jul. 21, 2016

(54) SAFETY-PRESSURE VALVE FOR COVERS OF AIR-TIGHT COOKERS

(71) Applicant: GUKANG CO., LTD., New Taipei City (TW)

(72) Inventor: Jin-Hong CHIEN, NEW TAIPEI CITY (TW)

(73) Assignee: GUKANG CO., LTD., NEW TAIPEI CITY (TW)

(21) Appl. No.: 14/598,488

(22) Filed: Jan. 16, 2015

(51) Int. Cl. A47J 27/09; F16K 24/04; F16K 24/06; F16K 17/19

(52) U.S. Cl. CPC A47J 27/09; F16K 17/19; F16K 24/04; F16K 24/06

(57) ABSTRACT

A safety-pressure valve used for covers of air-tight cookers, the safety-pressure valve is able to automatically open for contacting atmosphere when an outward positive pressure or an inward negative pressure in a cooker becomes too large over a safety value, and the pressure in the cooker can be balanced, thereby prevent the cover for the cooker from being damaged because of the overly large negative pressure. The cover is provided thereon with a through hole for receiving the safety-pressure valve, the safety-pressure valve is provided therein with a movable valve which normally is closed; when an inward negative pressure in the cooker becomes too large over the safety value because of lowering of temperature, the movable valve can automatically open to render air to flow into the cooker to balance the pressure in the cooker.

### BACKGROUND OF THE INVENTION

1. Field of the invention

The present invention is related to a safety-pressure valve used for covers of air-tight cookers, and especially to a safety-pressure valve able to automatically open for contacting atmosphere when an outward positive pressure or an inward negative pressure in a cooker becomes too large over a safety value, thus the pressure in the cooker can be balanced.

2. Description of the prior art

A conventional air-tight cooker is operated according to a principle of micro-pressure and heat circulation for the purpose of reducing cooking time. The cover of the air-tight cooker is provided on its outer peripheral rim with a seal ring, so that when the cover of the air-tight cooker is engaged with the upper rim of the cover, an air-tight space is formed in the interior of the cover that can avoid losing of heat energy in the cover, and raising the efficiency of heating.

When a user heats the cooker to cook food materials, water in the cooker will be gradually turned into steam to form a micro-pressuring state, hence after the cooker is stopped heating, the micro-pressuring state can lower the temperature of the boil point to maintain boiling of the water in the cooker, and thereby can provide an effect quasi closed steam cooking, and get the effect of saving energy.

However, by heating the cooker, when an overly large outward positive pressure is created in the cooker, the cover for the cooker might be spouted to fly to get a danger; in order to overcome the said problem, an air-tight cover for a cooker that can automatically let out pressure has appeared in the market, it mainly is provided with a through hole, and the through hole is provided therein with a movable valve which normally is closed. Thereby, when the cooker is created therein an outward positive pressure, the movable valve will automatically be pushed by the positive pressure to open the through hole to let out pressure, thus the cooker can maintain therein a constant pressure to prevent the cover for a cooker from the case of being spouted to fly.

Although the above movable valve may automatically let out pressure when an overly large outward positive pressure is created in the cooker, and when the cooker stops heating, air pressure in the cooker is reduced to create an inward negative pressure in the cooker, this makes the cover for the cooker hard to be opened, unless a hand is used to manipulate opening of the movable valve, otherwise the negative pressure which will get larger and larger and render the cover for the cooker to be collapsed; if the cover for the cooker is made of transparent strengthened glass, the cover for the cooker will continue lower its temperature to make the cooker create a negative pressure in the cooker and is too large over the safety value of the cooker pressure, this makes larger possibility that the material of the cover for the cooker may split because of its own defect, and thereby makes people's doubt of safety.

In view of these, the inventor of the present invention invented a safety-pressure valve used for covers of air-tight cookers based on his professional experience of years and after hard study, for the purpose of solving the problem of damaging a cover of a cooker because of an inward negative pressure in the cooker when it becomes too large over a safety value.

### SUMMARY OF THE INVENTION

The object of the present invention is to provide a safety-pressure valve used for covers of air-tight cookers, for the purpose when an overly large positive pressure is created in a cooker, the safety-pressure valve may automatically let out pressure, and when a negative pressure is created in the cooker and is over a safety value, the cooker can be automatically opened for contacting atmosphere, and thereby prevent the cover for the cooker from being damaged because of the overly large negative pressure.

In order to achieve the object, the cover for the cooker is provided on its outer peripheral rim with a seal ring that can seal up the peripheral rim of the cooker, and the cover for the cooker is provided thereon with a through hole, wherein:

the safety-pressure valve is provided in the through hole, and is provided with an air-tight cap that is protruding out of the top of the cover for the cooker and has an outer radius larger than the inner radius of the through hole, a hollow air ventilation part is provided beneath the air-tight cap and can be moved upwards and downwards in the through hole, further, a position limiting ring is provided on and around the bottom of the hollow air ventilation part having an outer radius larger than the inner radius of the through hole; with the safety-pressure valve, when an overly large outward positive pressure is created in a cooker, the positive pressure can push to move the air-tight cap and the hollow air ventilation part upwardly to make the interior of the cooker contact with the outside atmosphere, and to relieve the air-tight state between the cover for the cover and the cooker and let out the pressure;

the said air-tight cap has a receiving space which has an upper and a lower opening to make contact between the outside atmosphere and the hollow air ventilation part, the receiving space has a movable valve plug normally sealing the upper opening, when a negative pressure is created in the cooker and is overly large, the negative pressure absorbs and makes the movable valve plug move downwards, thus the negative pressure in the cooker can contact the outside atmosphere through the upper and the lower openings of the receiving space to relieve the negative pressure between the cover and the cooker.

With the above stated structure, having the safety-pressure valve of the present invention, when an overly large outward positive pressure is created in the cooker, the positive pressure can push to move the safety-pressure valve upwardly to contact the outside atmosphere through the hollow air ventilation part, thereby to remove the air-tight state between the cover and the cooker and let out the pressure; and when an overly large negative pressure is created in a cooker, the negative pressure absorbs the safety-pressure valve to recover its position and seal tight the through hole, if the negative pressure continues to be created to be over the safety value, the movable valve plug will be absorbed by the negative pressure to move downwardly, thus the negative pressure in the cooker can contact the outside atmosphere through the upper and the lower openings of the receiving space to balance the pressure in the cooker.

When in practice, a top surface of the movable valve plug and a bottom surface of the upper opening are provided therebetween with two magnets able to mutually absorb and thus normally make the movable valve plug seal the upper opening.

And in practice, the movable valve plug further includes a spring that is used to abut against the movable valve plug to render the movable valve plug normally to seal the upper opening and includes a positioning annulus provided above the lower opening.

And in practice, the hollow air ventilation part is like a soft pipe for a user to push the air-tight cap sideways and render the hollow air ventilation part to move upwardly.

Further in practice, the through hole is provided in the center of the cover for the cooker, and is provided therein with a handle component for the user to pick up; the handle component includes a handle having on its one end a through opening, and a connecting seat to fixedly connect with the through hole and the through opening. The connecting seat is provided on the peripheral of its bottom with a protruding annulus with an outer radius larger than that of the through hole, further, the connecting seat is provided around it with a collar next to the top of the through hole of the cover for the cooker, and is provided with a buffering annulus between the bottom of the through hole of the cover and the protruding annulus; the connecting seat is provided on it with a fixing hole to contact the outer atmosphere, the above mentioned safety-pressure valve is provided in the fixing hole and reveals itself in the through opening of the handle, in order that the safety-pressure valve can get through the fixing hole of the handle component and is positioned indirectly in the through hole.

The present invention will be apparent according to its technical measures after reading the detailed description of the preferred embodiment thereof in reference to the accompanying drawings.

### BRIEF DESCRIPTION OF THE DRAWINGS

FIG. 1 is a perspective view showing the location of an embodiment of a safety-pressure valve of the present invention;

FIG. 2 is a perspective view showing parts of the embodiment of the safety-pressure valve of the present invention;

FIG. 3 is a sectional schematic view showing the structure of the safety-pressure valve of the present invention;

FIG. 4 is a sectional schematic view showing a sealed through hole of the safety-pressure valve of the present invention;

FIG. 5 is a sectional schematic view showing the safety-pressure valve of the present invention is pushed and moved upwards by an outward positive pressure in the cooker to let out the pressure;

FIG. 6 is a sectional schematic view showing the safety-pressure valve of the present invention is moved downwards by absorption of a negative pressure in the cooker to tightly seal the through hole;

FIG. 7 is a sectional schematic view showing a user manually pushes an air-tight cap to balance the negative pressure in the cooker;

FIG. 8 is a sectional schematic view showing that the negative pressure in the cooker absorbs the safety-pressure valve of the present invention and automatically opens a movable valve plug;

FIG. 9 is a perspective view showing another location of the safety-pressure valve of the present invention;

FIG. 10 is a perspective view showing parts of the second embodiment of the safety-pressure valve of the present invention;

FIG. 11 is a sectional schematic view showing the structure of the second embodiment of a safety-pressure valve of the present invention;

FIG. 12 is a sectional schematic view showing that the negative pressure in the cooker absorbs the safety-pressure valve of the present invention and automatically opens a movable valve plug;

### DETAILED DESCRIPTION OF THE PREFERRED EMBODIMENT

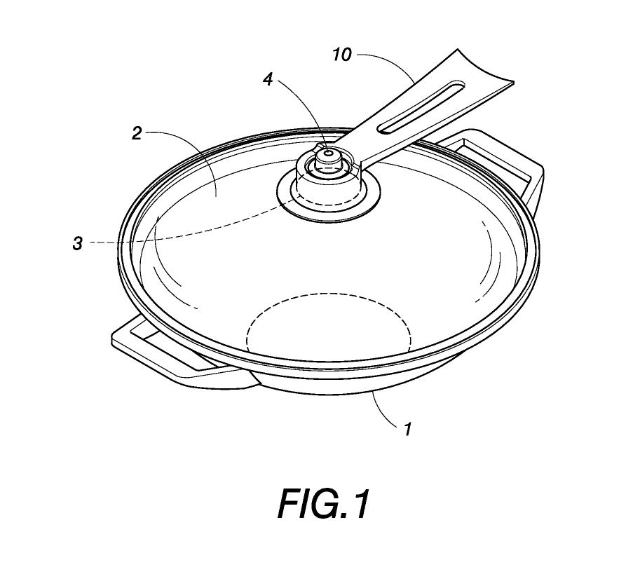

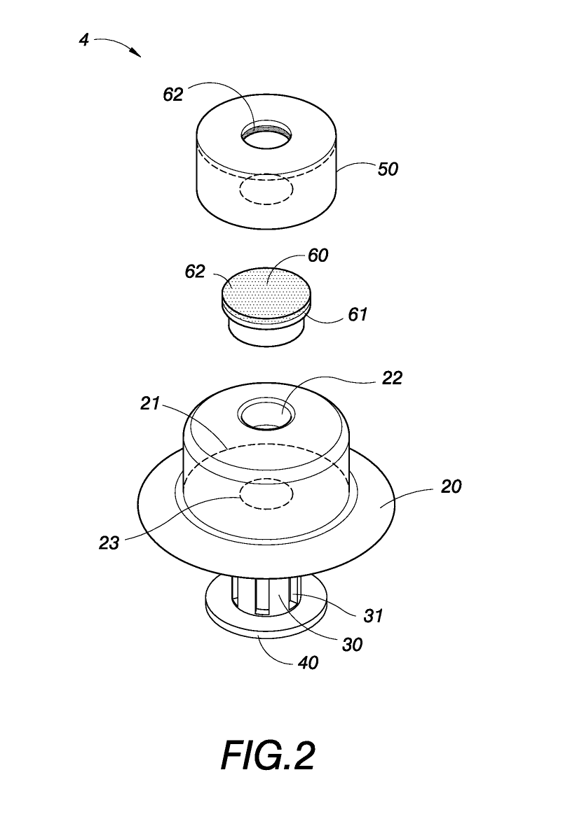

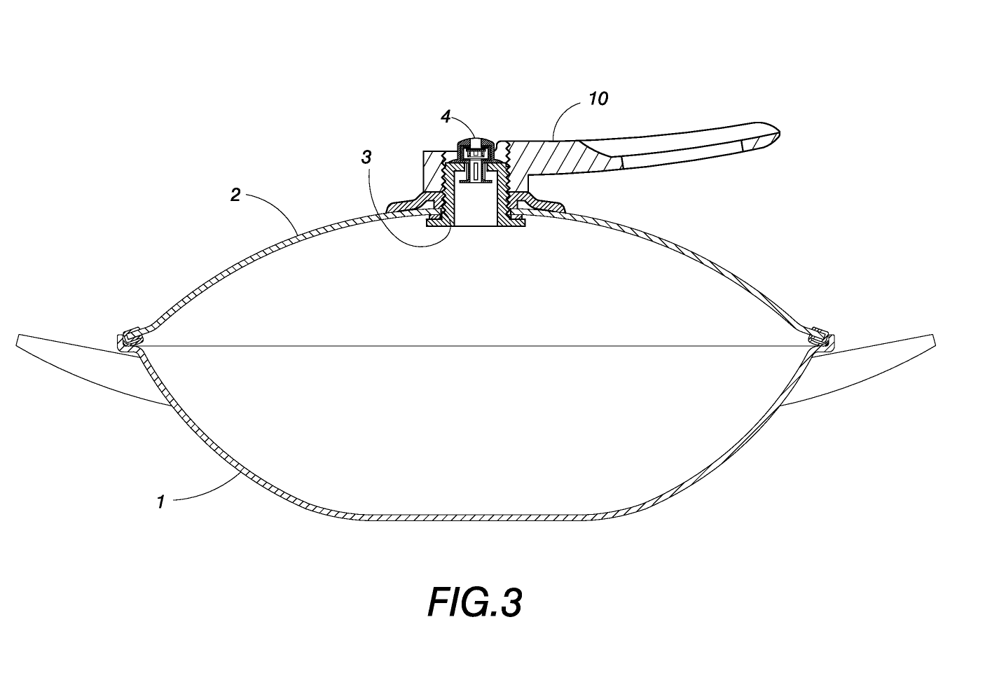

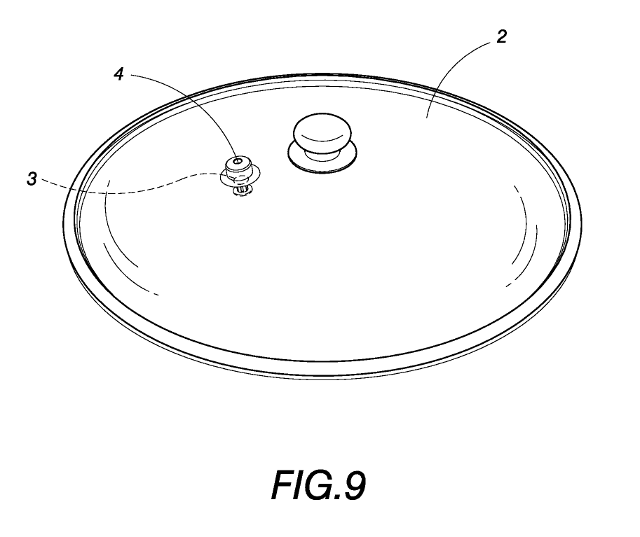

As shown in FIG. 1, an air-tight cooker includes a cooker 1 and a cover 2, the cover 2 is provided on its outer peripheral rim with a seal ring that can seal up the peripheral rim of the cooker 1, and the cover 2 is provided thereon with a through hole 3, a safety-pressure valve 4 is provided directly in the through hole 3 as shown in FIG. 9, or as shown in FIGS. 1 to 8, the through hole 3 is provided in the center of the cover 2, and the through hole 3 is provided therein with a handle component 10 for a user to pick up; the safety-pressure valve 4 is provided on the handle component 10 and is positioned indirectly in the through hole 3. In practice, the cover 2 can be made of strengthened transparent glass.

The handle component 10 includes a handle 12 having on its one end a through opening 11, and includes a connecting seat 13 to fixedly connect with the through hole 3 and the through opening 11. The connecting seat 13 is provided on the peripheral of its bottom with a protruding annulus 14 with an outer radius larger than that of the through hole 3, further, the connecting seat 13 is provided around it with a collar 15 next to the top of the through hole 3 of the cover 2, and is provided with a buffering annulus 16 between the cover 2 and the protruding annulus 14; the connecting seat 13 is provided on it with a fixing hole 17 to contact the outer atmosphere, the above mentioned safety-pressure valve 4 is provided in the fixing hole 17 and reveals itself in the through opening 11 of the handle 12, in order that the safety-pressure valve 4 can get through the fixing hole 17 of the handle component 10 and is positioned indirectly in the through hole 3. And in practice, the connecting seat 13 is provided on its outside wall with an outside screw thread, the through opening 11 of the handle 12 is provided on its inside wall with an inner screw thread being matched and connected with the outside screw thread.

As shown in FIG. 1 to FIG. 3, the through hole 3 is provided in the center of the cover 2, and the through hole 3 is provided therein with the handle component 10 for a user to pick up; the handle component 10 is provided with the fixing hole 17 in order when the safety-pressure valve 4 is installed, the safety-pressure valve 4 can be moved through the fixing hole 17 of the handle component 10 to be positioned indirectly in the through hole 3. The safety-pressure valve 4 is provided with an air-tight cap 20 that is protruding out of the top of the fixing hole 17 and has an outer radius larger than the fixing hole 17, a hollow air ventilation part 30 is provided beneath the air-tight cap 20 with a length longer than the depth of the fixing hole 17 and can be moved upwards and downwards in the fixing hole 17, further, a position limiting ring 40 is provided on and around the bottom of the hollow air ventilation part 30 having an outer radius larger than the inner radius of the through hole 17. In practice, the hollow air ventilation part 30 has on its peripheral wall a plurality of through holes 31 that are communicated with an internal hollow space of the hollow air ventilation part.

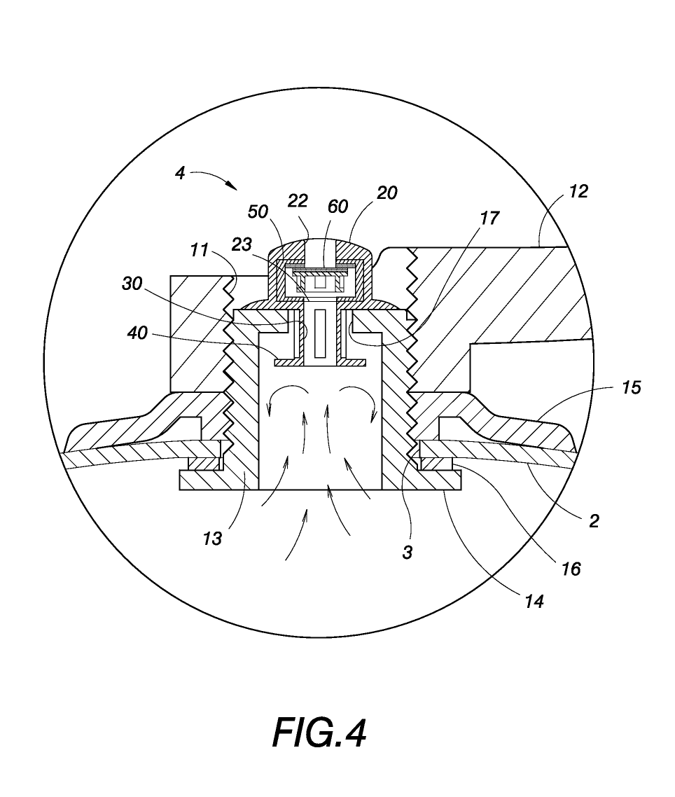

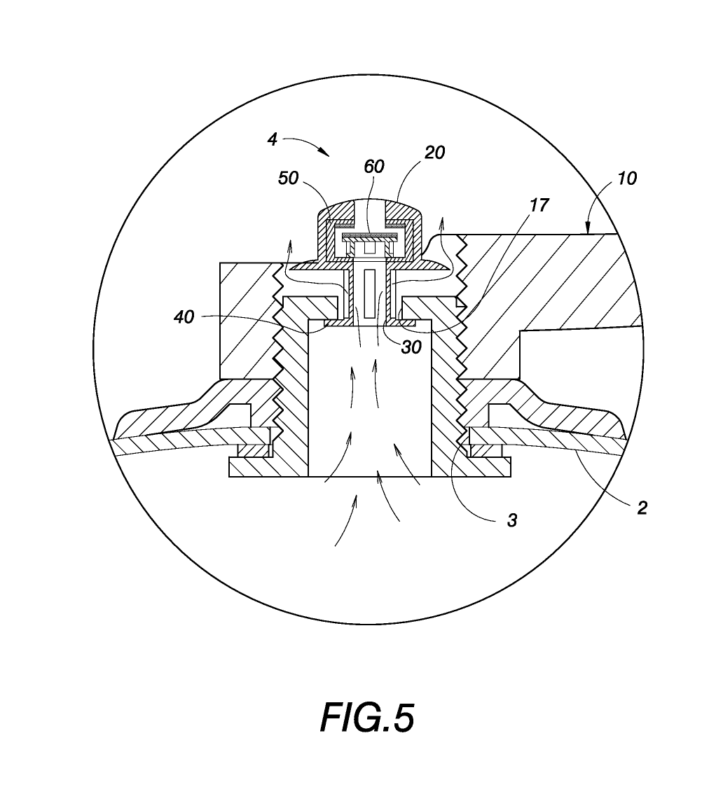

Referring to FIG. 4, when the cooker 1 is heating to gradually generate an outward positive pressure in the cooker 1, when the set value of the outward positive pressure in the cooker 1 is over the set value, as shown in FIG. 5, the outward positive pressure will push the air-tight cap 20 and the hollow air ventilation part 30 and move them upwardly to make contact of the cooker 1 with the outside atmosphere to relieve the air-tight state between the cover 2 and the cooker 1 to let out pressure.

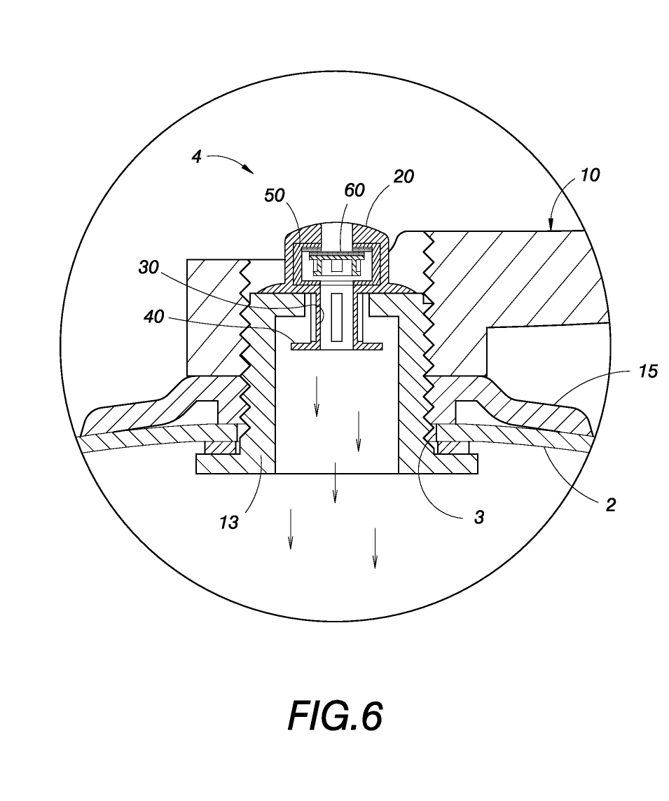

Referring to FIG. 6, when the cooker 1 is stopped heating to generate an inward negative pressure, the safety-pressure valve 4 will be restored to its position by absorption, thus the cover 2 will be restored to its air-tight state, and the food material will easier to release its essence into a soup, this will increase the delicious of food.

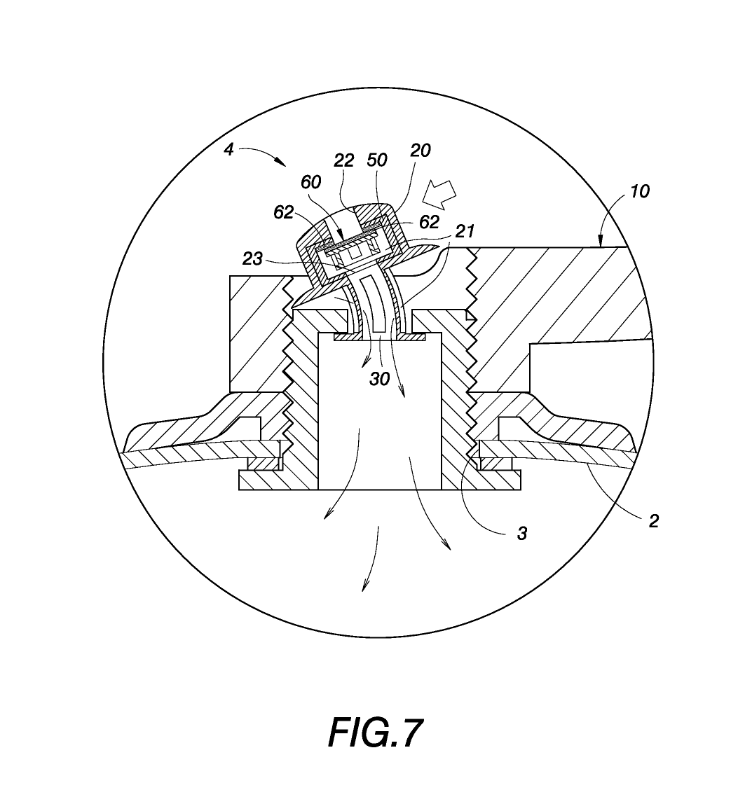

Referring to FIG. 7, the air-tight cap 20 has a receiving space 21 which has an upper and a lower opening 22, 23 to make contact between the outside atmosphere and the hollow air ventilation part 30; the receiving space 21 is further provided therein with a positioning sleeve 50 having a shape matched with the receiving space 21, and having an inner top surface located beneath the bottom of the upper opening 22, the positioning sleeve 50 is provided therein with a movable valve plug 60 normally sealing the upper opening 22; when in practice, the movable valve plug 60 is provided around it with a stop annulus 61 with a radius larger than that of the upper opening 22 of the receiving space 21, in order to prevent the movable valve plug 60 from dropping out of the receiving space 21.

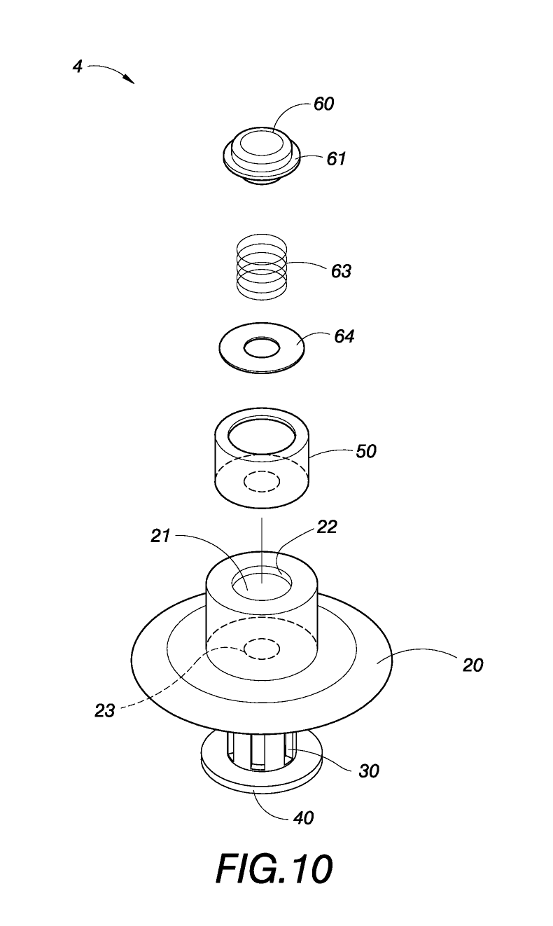

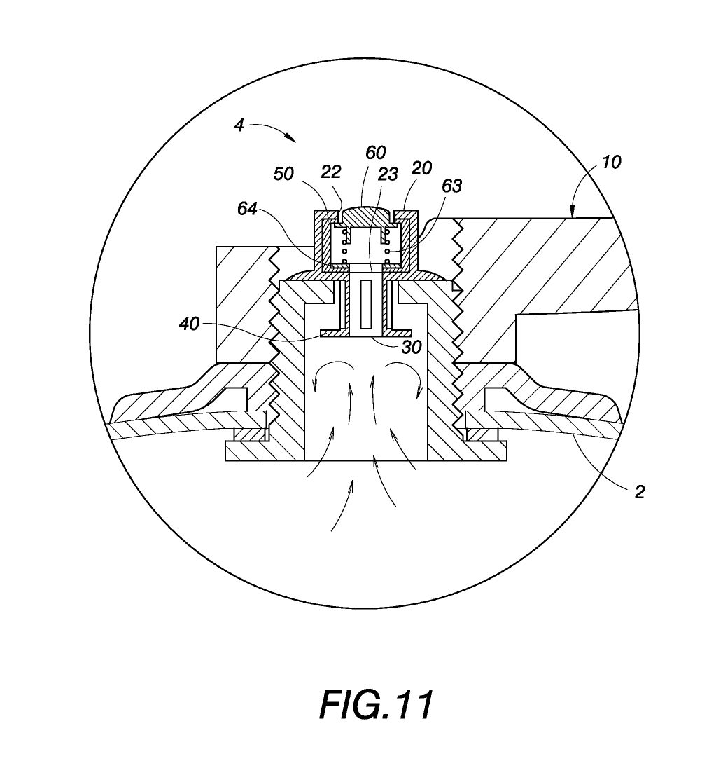

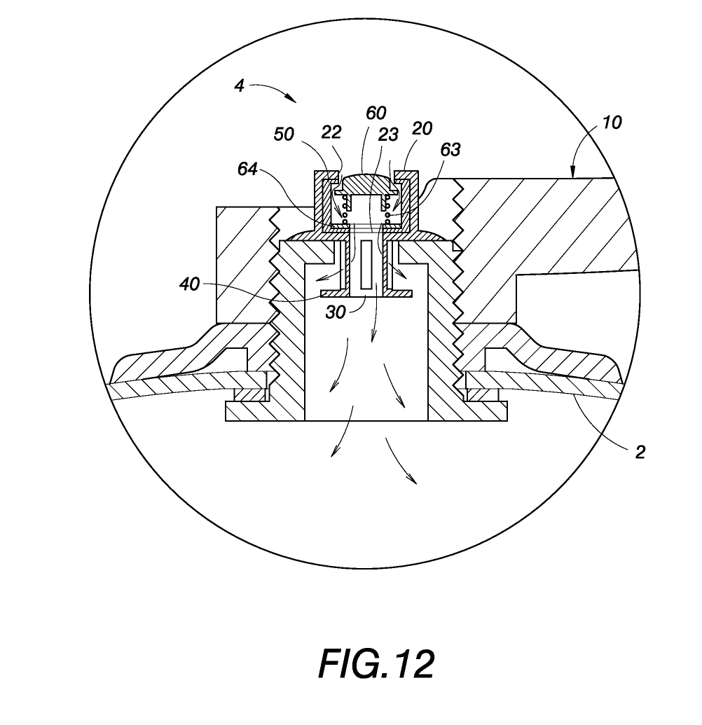

In practice, the top of the movable valve plug 60 and the bottom of the upper opening 22 are provided each with a magnet component 62, these magnet components 62 normally can render the movable valve plug 60 to seal the upper opening 22; in FIG. 7, the bottom of the upper opening 22 is provided with the positioning sleeve 50, hence the magnet components 62 are respectively provided on the top of the movable valve plug 60 and located beneath the upper opening 22 and are provided in the positioning sleeve 50; as shown in FIGS. 10-12, the movable valve plug 60 further includes a spring 63 and a positioning annulus 64 provided above the lower opening 23, the spring 63 can be abutted against the movable valve plug 60 to render the movable valve plug 60 to normally seal the upper opening 22.

When in assembling, the movable valve plug 60, the spring 63 and the positioning annulus 64 can be provided firstly into the positioning sleeve 50, and then the positioning sleeve 50 can be put into the receiving space 21 of the air-tight cap 20.

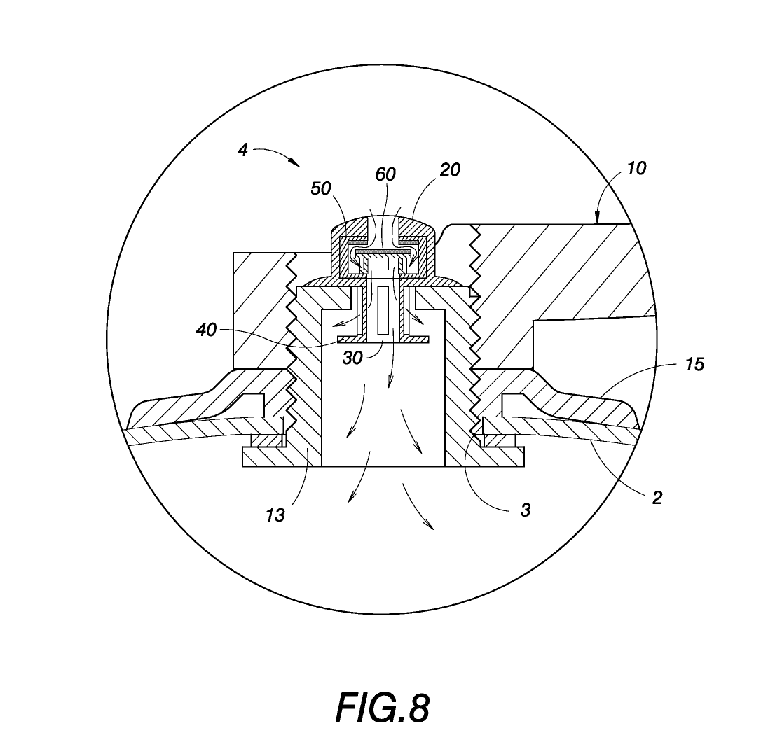

The hollow air ventilation part 30 is a soft pipe, when an overly large negative pressure is created in the cooker 1, a user can manually push the air-tight cap 20 sideways to render the hollow air ventilation part 30 to move upwardly and to render the overly large negative pressure in the cooker 1 to get through the upper and a lower openings 22, 23 of the receiving space 21 to contact the outside atmosphere to relieve the air-tight state between the cover 2 and the cooker 1 to let out pressure, or an automatic way is used as shown in FIG. 8, wherein the negative pressure in the cooker 1 can absorb the movable valve plug 60 and automatically moves it down to make the cooker 1 contact the outside atmosphere and thereby balance the negative pressure in the cooker 1.

With the above stated structure, when the safety-pressure valve 4 of the present invention creates an overly large positive pressure in the cooker 1, it can be pushed upwardly by the positive pressure to make the cooker 1 contact the outside atmosphere through the hollow air ventilation part 30, and thus to relieve the air-tight state between the cover 2 and the cooker 1 to let out pressure; when a negative pressure is created in the cooker 1, the negative pressure absorbs and makes the movable valve plug 4 restore to its position and is sealed, when the negative pressure is over the safety value, the movable valve plug 60 will be absorbed by the negative pressure to move downwardly, thus the negative pressure in the cooker 1 can contact the outside atmosphere through the upper and the lower openings 22, 23 of the receiving space 21 to balance the pressure in the cooker 1.

The preferred embodiments shown and described is only for illustrating the present invention, and not for giving any limitation to the scope of the present invention; it will be apparent to those skilled in this art that various equivalent modifications or changes without departing from the spirit of this invention shall also fall within the scope of the appended claims.

1. A safety-pressure valve used for a cover of an air-tight cooker, said cover for said cooker is provided on its outer peripheral rim with a seal ring that is adapted to seal up said peripheral rim of said cooker, and said cover is provided thereon with a through hole, wherein:
said safety-pressure valve is provided in said through hole, and said safety-pressure valve is provided with an air-tight cap that is protruding out of a top of said cover for said cooker and has an outer radius larger than an inner radius of said through hole, a hollow air ventilation part is provided beneath said air-tight cap and is adapted to be moved upwards and downwards in said through hole, further, a position limiting ring is provided on and around a bottom of said hollow air ventilation part having an outer radius larger than an inner radius of said through hole, with said safety-pressure valve, when an overly large outward positive pressure is created in said cooker, said positive pressure is adapted to push to move said air-tight cap and said hollow air ventilation part upwardly to make interior of said cooker contact with outside atmosphere, and to relieve air-tight state between said cover for said cooker and let out pressure,
said safety-pressure valve is characterized in that:
said air-tight cap has a receiving space which has an upper and a lower opening to make contact between outside atmosphere and said hollow air ventilation part, said receiving space has a movable valve plug normally sealing said upper opening, when a negative pressure is created in said cooker and is overly large, said negative pressure absorbs and makes said movable valve plug move downwards, thus said negative pressure in said cooker contacts outside atmosphere through said upper and said lower openings of said receiving space to relieve said negative pressure between said cover and said cooker.

2. The safety-pressure valve used for a cover of an air-tight cooker as in claim 1, wherein a top surface of said safety-pressure valve and a bottom surface of said upper opening are provided therebetween with two magnet components adapted to mutually absorb and thus normally make said movable valve plug seal said upper opening.

3. The safety-pressure valve used for a cover of an air-tight cooker as in claim 2, wherein said receiving space of said air-tight cap is further provided therein with a positioning sleeve having a shape matched with said receiving space, said positioning sleeve has an inner top surface located beneath said bottom of said upper opening, said movable valve plug is provided in said positioning sleeve, and said magnet components are provided on said top of said movable valve plug and located beneath said upper opening and are provided in said positioning sleeve.

4. The safety-pressure valve used for a cover of an air-tight cooker as in claim 2, wherein said movable valve plug is provided around it with a stop annulus with a radius larger than that of said upper opening of said receiving space.

5. The safety-pressure valve used for a cover of an air-tight cooker as in claim 2, wherein said hollow air ventilation part has on its peripheral wall a plurality of through holes that are communicated with an internal hollow space of said hollow air ventilation part.

6. The safety-pressure valve used for a cover of an air-tight cooker as in claim 2, wherein said hollow air ventilation part is like a soft pipe for a user to push said air-tight cap sideways and render said hollow air ventilation part to move upwardly.

7. The safety-pressure valve used for a cover of an air-tight cooker as in claim 2, wherein said through hole is provided in center of said cover for said cooker, and is provided therein with a handle component for a user to pick up; said handle component includes a handle having on its one end a through opening, and a connecting seat to fixedly connect with said through hole and said through opening; said connecting seat is provided on a peripheral of its bottom with a protruding annulus with an outer radius larger than that of said through hole, further, said connecting seat is provided around it with a collar next to top of said through hole of said cover for said cooker, and is provided with a buffering annulus between said bottom of said through hole of said cover and said protruding annulus; said connecting seat is provided on it with a fixing hole to contact outer atmosphere, said safety-pressure valve is provided in said fixing hole and reveals itself in said through opening of said handle, in order that said safety-pressure valve is adapted to get through said fixing hole of said handle component and is positioned indirectly in said through hole.

8. The safety-pressure valve used for a cover of an air-tight cooker as in claim 7, wherein said connecting seat is provided on its outside wall with an outside screw thread, said through opening of said handle is provided on its inside wall with an inner screw thread being matched and connected with said outside screw thread.

9. The safety-pressure valve used for a cover of an air-tight cooker as in claim 2, wherein said cover for said cooker is made of transparent strengthened glass.

10. The safety-pressure valve used for a cover of an air-tight cooker as in claim 1, wherein said movable valve plug further includes a spring that is used to abut against said movable valve plug to render said movable valve plug normally to seal said upper opening and includes a positioning annulus provided above said lower opening.

11. The safety-pressure valve used for a cover of an air-tight cooker as in claim 10, wherein said receiving space of said air-tight cap is further provided therein with a positioning sleeve having a shape matched with said receiving space, said movable valve plug is provided in said positioning sleeve.

12. The safety-pressure valve used for a cover of an air-tight cooker as in claim 10, wherein said movable valve plug is provided around it with a stop annulus with a radius larger than that of said upper opening of said receiving space.

13. The safety-pressure valve used for a cover of an air-tight cooker as in claim 10, wherein said hollow air ventilation part has on its peripheral wall a plurality of through holes that are communicated with an internal hollow space of said hollow air ventilation part.

14. The safety-pressure valve used for a cover of an air-tight cooker as in claim 10, wherein said hollow air ventilation part is like a soft pipe for a user to push said air-tight cap sideways and render said hollow air ventilation part to move upwardly.

15. The safety-pressure valve used for a cover of an air-tight cooker as in claim 10, wherein said through hole is provided in center of said cover for said cooker, and is provided therein with a handle component for a user to pickup; said handle component includes a handle having on its one end a through opening, and a connecting seat to fixedly connect with said through hole and said through opening; said connecting seat is provided on a peripheral of its bottom with a protruding annulus with an outer radius larger than that of said through hole, further, said connecting seat is provided around it with a collar next to top of said through hole of said cover for said cooker, and is provided with a buffering annulus between said bottom of said through hole of said cover and said protruding annulus; said connecting seat is provided on it with a fixing hole to contact outer atmosphere, said safety-pressure valve is provided in said fixing hole and reveals itself in said through opening of said handle, in order that said safety-pressure valve is adapted to get through said fixing hole of said handle component and is positioned indirectly in said through hole.

16. The safety-pressure valve used for a cover of an air-tight cooker as in claim 15, wherein said connecting seat is provided on its outside wall with an outside screw thread, said through opening of said handle is provided on its inside wall with an inner screw thread being matched and connected with said outside screw thread.

17. The safety-pressure valve used for a cover of an air-tight cooker as in claim 10, wherein said cover for said cooker is made of transparent strengthened glass.
